(19) United States
(12) Patent Application Publication
(10) Pub. No.: US 2014/0357330 A1
(43) Pub. Date: Dec. 4, 2014

(54) CELL PHONE CASE WITH TEMPLATES FOR PHOTOGRAPH COLLAGE OR MELANGE

(71) Applicant: Alan Nathan Lin, Arcadia, CA (US)

(72) Inventor: Alan Nathan Lin, Arcadia, CA (US)

(21) Appl. No.: 13/904,845

(22) Filed: May 29, 2013

(51) Int. Cl. H04M 1/02

(52) U.S. Cl. CPC H04M 1/0266
USPC 455/575.8

(57) ABSTRACT

A protective case for an electronic device comprises a main frame with clear display panel as collage template to be able to display photographs and/or artworks. In one embodiment, the clear display panel is removable and interchangeable; so that the user has the flexibility of changing to a different display panel which serves as the collage template, therefore, the user is able to display their favorite photographs and/or artworks at their own convenience.

### FIELD OF THE INVENTION

The present invention relates to the accessories for electronic devices such as cell phones and more particularly a protective case for such devices.

### BACKGROUND OF THE INVENTION

Cell phone has been one the most popular electronic devices for over a decade. It has been developed throughout the years with the newest technology for example fastest speed of the processor, high definition of the multi-touch graphic display screen. In the meantime, in the domain of the accessories, there has been a lot going on with the development to meet the needs of the consumers. Cell phone cases of the prior art are originally designed to carry around the phones and as well as to protect them. There are cases with different designs and purposes. For example, there are cases designed with one or more different materials for the look as well the functionality.

Thus, there is a need for an improved case for an electronic device such as cell phone or tablet computer that provides protection for the device with a fashionable look, with customizable photograph templates that the user is able to switch their own favorite photographs at their conveniences.

### SUMMARY

The object of the present invention is to meet the needs of the users in the market of the electronic device accessories, in particularly the protective case.

An embodiment of the present invention may therefore comprise a protective case with collage template for the user to be able to easily change their favorite photographs at their convenience and any time. The protective case itself may be made with soft or flexible material or may be made with hard plastic or any other hard material that could possibly be used to make the protective for electronic devices.

An embodiment of the present invention may further comprise a protective case with a fixed photograph collage template on the case itself, where the affixed template is built-in on the rear side of the protective case of the electronic device. The affixed built-in template may be divided into one, two, three or more windows to display the photographs.

An embodiment of the present invention may further comprise a protective case with a removable photograph collage template, so that the user is able to change the template, for example they can change from one-photograph-collage display template to two-photograph-collage display template, or even more than two-photograph-collage display template.

An embodiment of the present invention may further comprise a protective case with one or more anti-dust covers, which are made with the same material as the main frame of the protective case of the present invention. These anti-dust covers are simply used to protect the electronic device from dust to get into the ports—either charging port, USB port or audio/video port.

### BRIEF DESCRIPTION OF THE DRAWINGS

FIG. 1 is an isometric view of a complete assembly of a protective case according to one embodiment of the present invention;

FIG. 2 is an isometric view of a complete assembly of a protective case according to one embodiment of the present invention;

FIG. 3 is an isometric of an exploded view of the embodiment of FIG. 1;

FIG. 4 is an isometric of an exploded view of the embodiment of FIG. 2;

FIG. 5 is a rear elevational view of a protective case according to one embodiment of the present invention;

FIG. 6 is an illustrated exterior view of one dust cover of one embodiment of the present invention;

FIG. 7 is an illustrated interior view of one dust cover of one embodiment of the present invention;

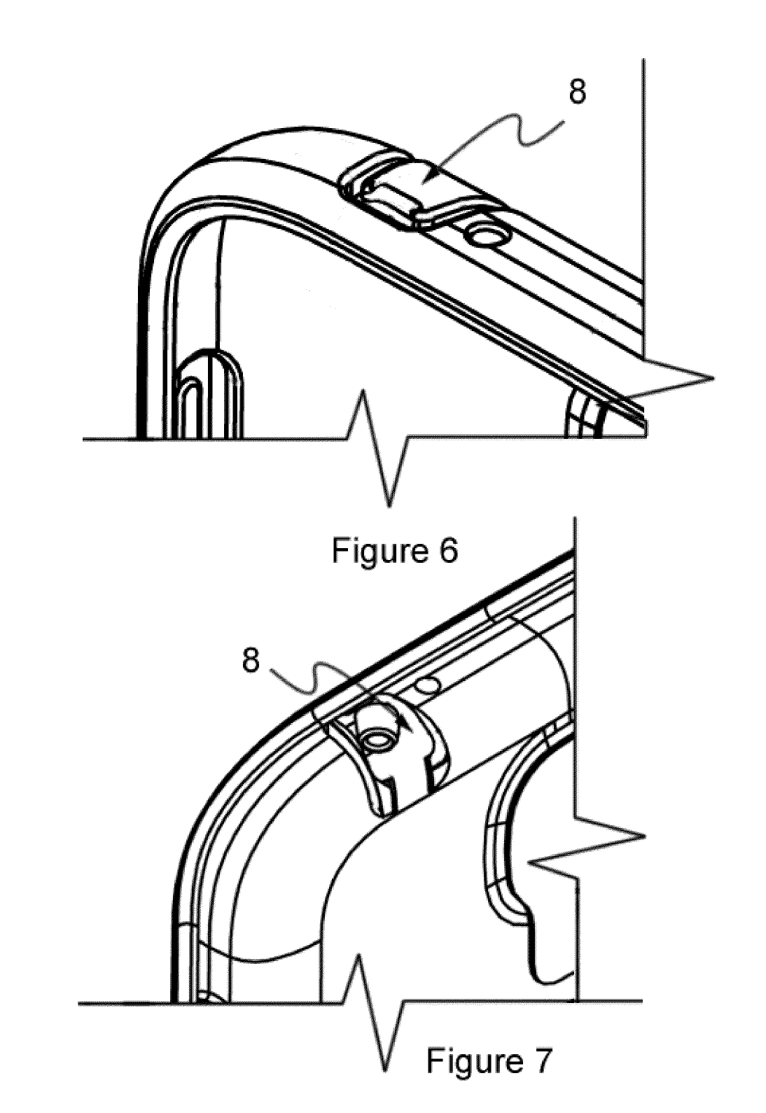

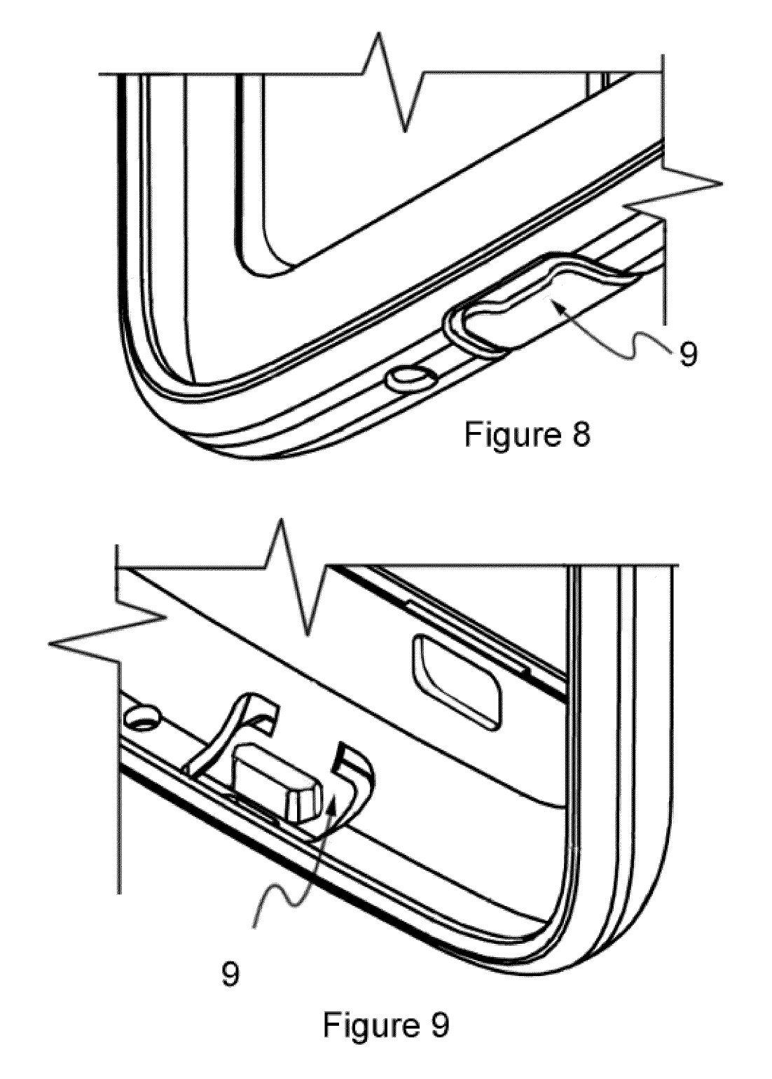

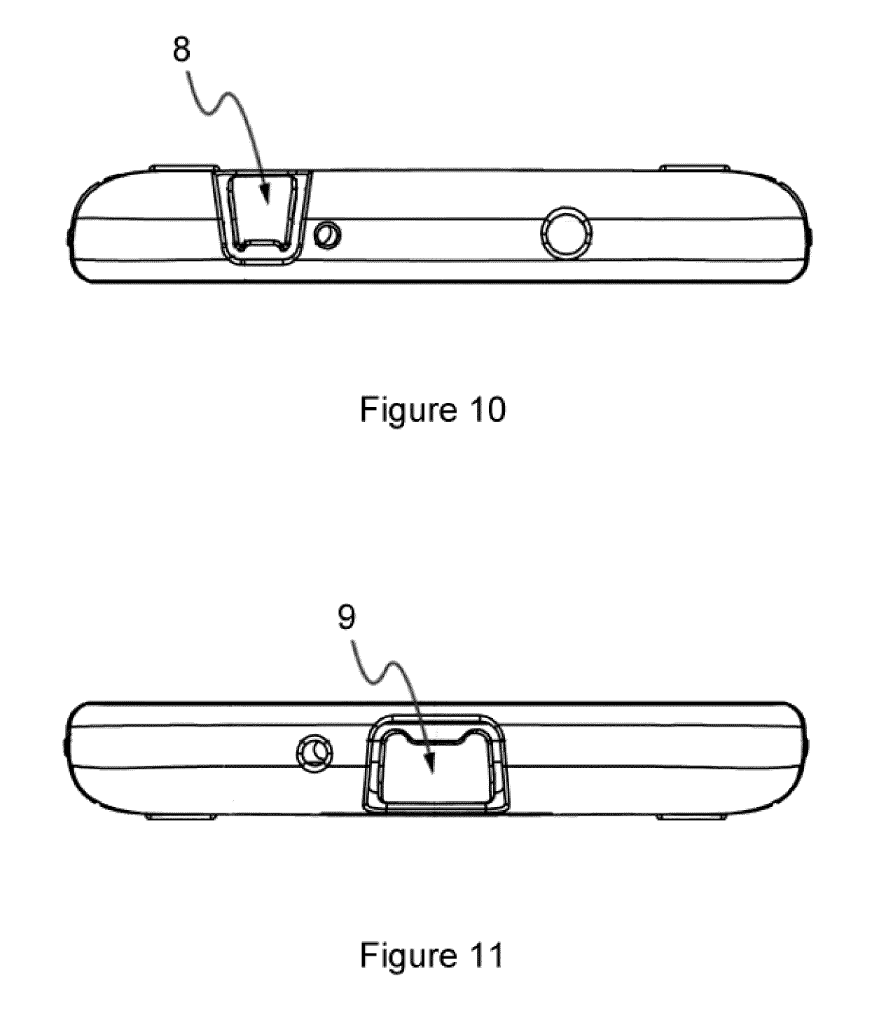

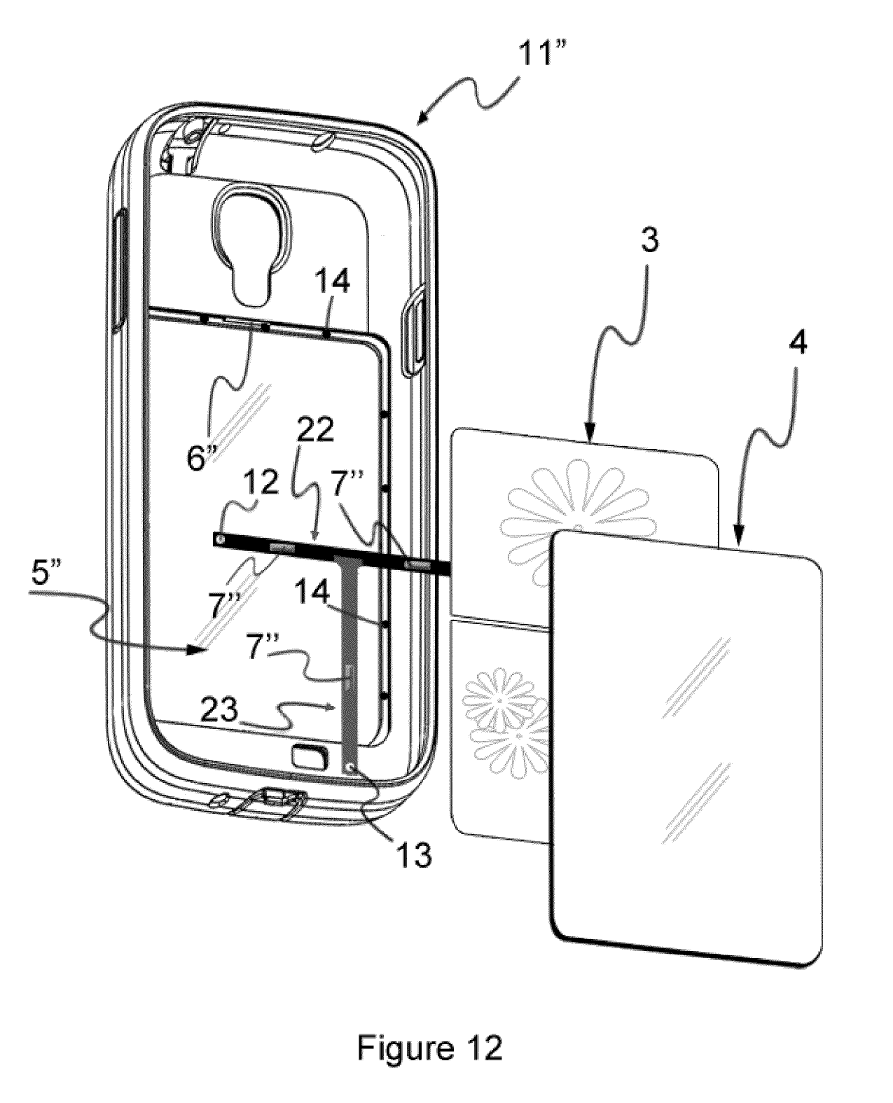

FIG. 6 is an illustrated exterior view of one dust cover of the audio port of one embodiment of the present invention;

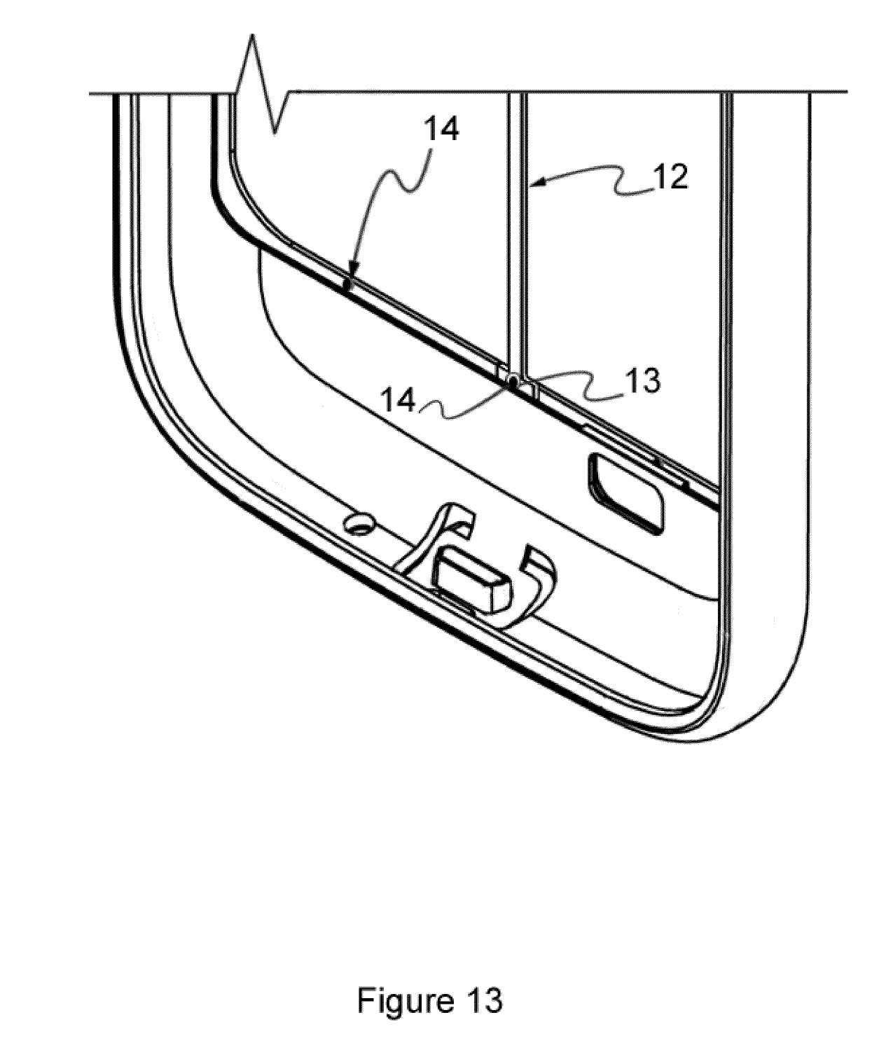

FIG. 7 is an illustrated interior view of one dust cover of the audio port of one embodiment of the present invention;

FIG. 8 is an illustrated exterior view of one dust cover of the charger port of one embodiment of the present invention;

FIG. 9 is an illustrated interior view of one dust cover of the charger port of one embodiment of the present invention;

FIG. 10 is a top view of one embodiment of the present invention;

FIG. 11 is a top view of one embodiment of the present invention;

FIG. 12 is an isometric of exploded view of an embodiment of the present invention;

FIG. 13 is an illustrated interior view of the series of connectors of an embodiment of the present invention.

### DETAILED DESCRIPTION OF THE EMBODIMENTS OF THE PRESENT INVENTION

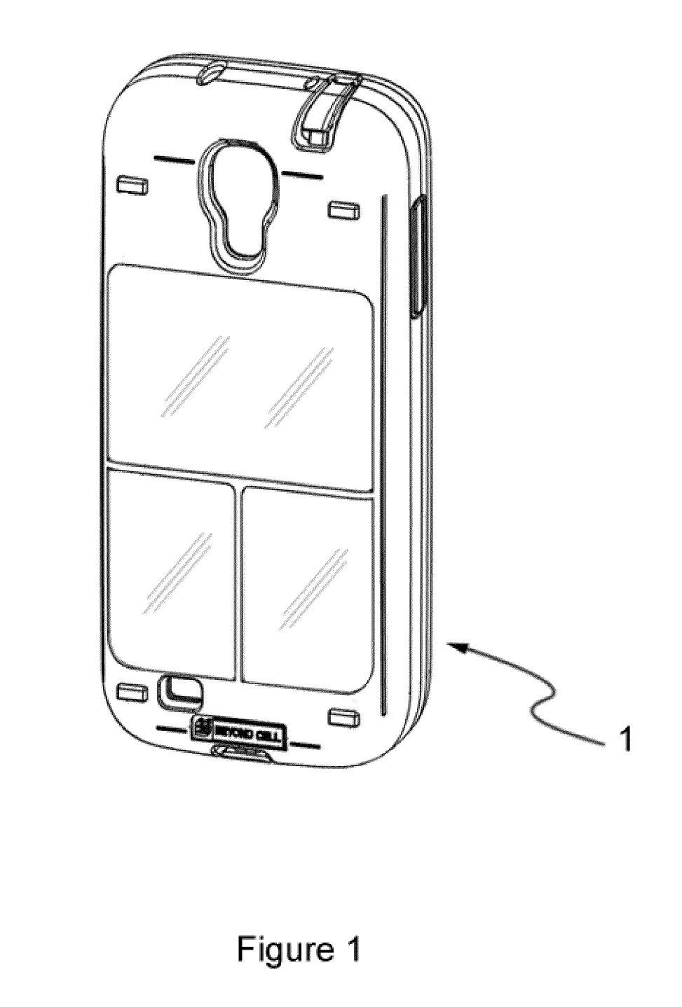

According to an embodiment of the present invention, FIG. 1 of the drawings shown a complete assembly of an embodiment of a protective case 1 for an electronic device formed with different components. The protective case 1 is formed with the main frame 11, in which built-in the clear panel or template 5 functioning as a display windows, to display the photographs 3. The clear panel or template 5, which is considered as the display window, is divided into multiple display windows; in which user is able to display their favorite photographs 3 according to the fixed clear panel or template 5, which is built-in to the main frame 11. The photographs 3 are cut in accordance with the clear panel or template 5, so that the photographs 3 are able to be nicely displayed through the multiple display windows of the clear panel or template 5. In order for the photographs 3 to stay in place during and after the assembly, on the clear panel or template 5, there are 1 or more tab stoppers 7 to define the positions of each photograph of the photographs 3. These tab stoppers 7 could be any geometrical shapes, whichever is more convenient for users. After having placed the photographs, another interior panel 4 which can be transparent or opaque, will be snapped in place. This interior panel 4 is held in position by one or more latches 6, which are built-in on the main frame 11.

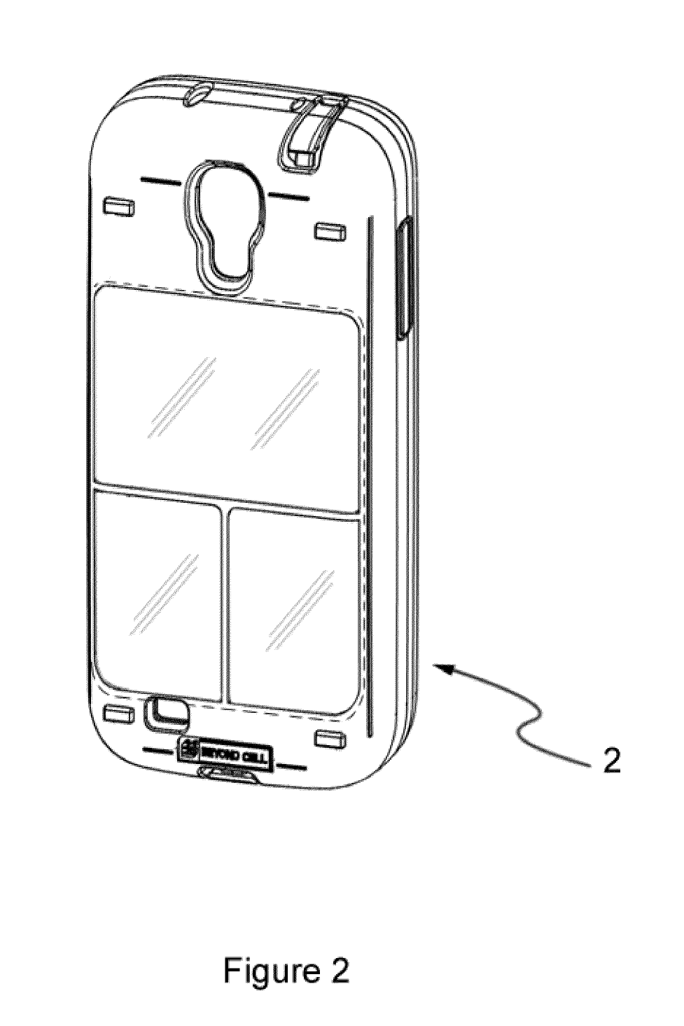

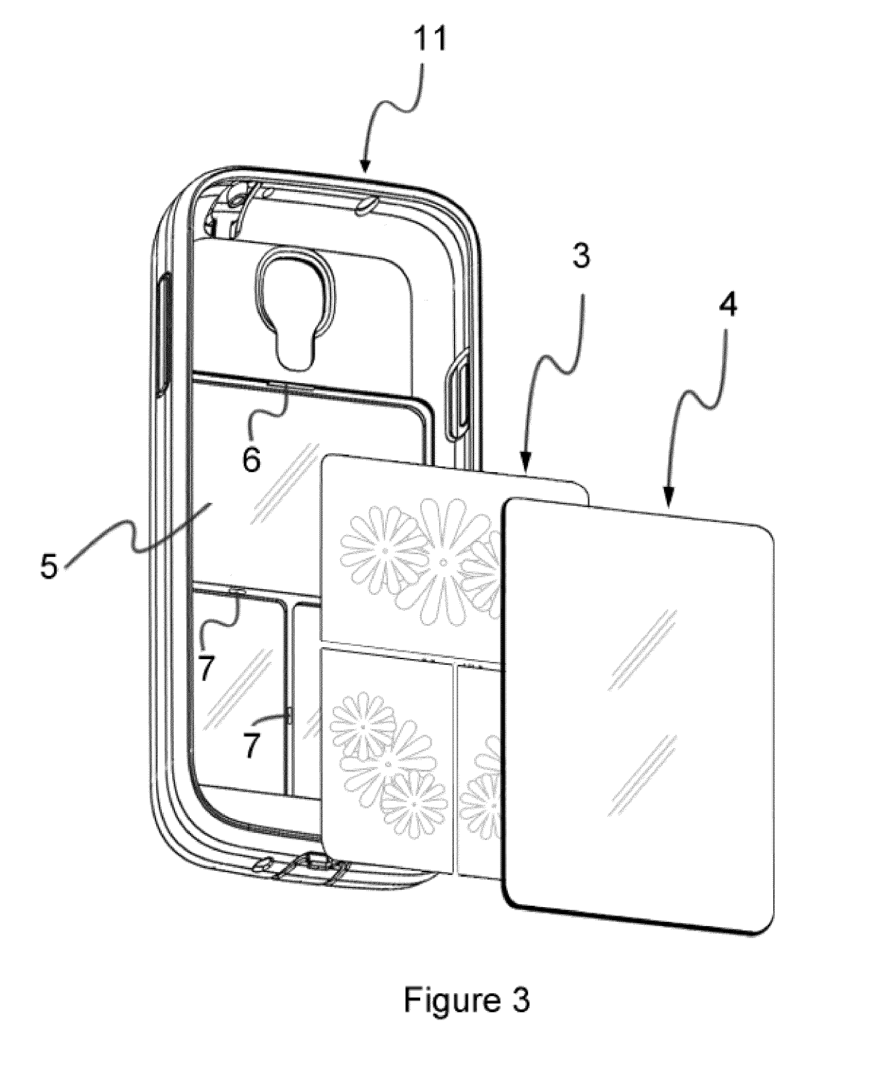

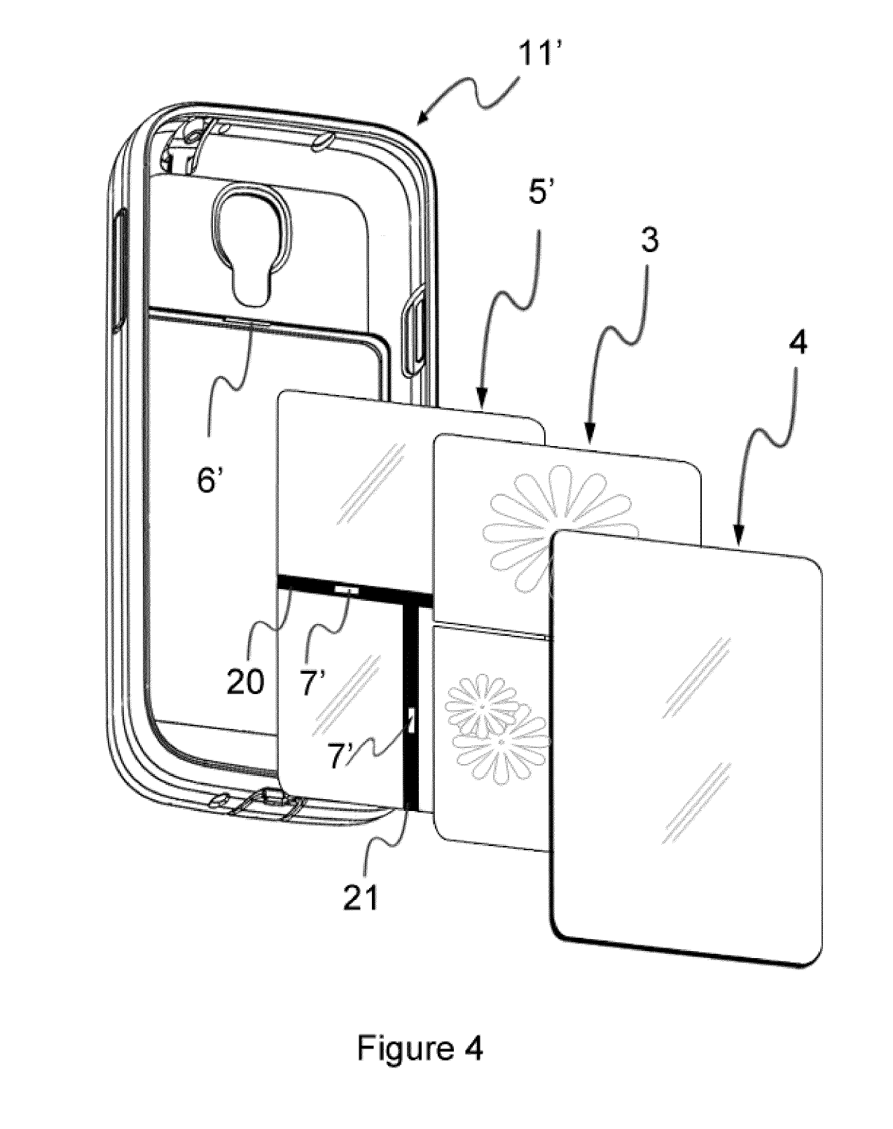

With reference to FIG. 4, an exploded view of an embodiment of protective case 2 of the FIG. 2, the complete assembly of a protective case 2 of an electronic device is formed with main frame 11′. The main frame 11′ has recess along the edge of the middle opening to accommodate the removable clear panel or template 5′ which is considered as display windows, the photographs 3 and the interior panel 4. The removable clear panel or template 5′ may be divided into the multiple display windows. It may be divided by the 1 or more horizontal bars 20 or vertical bars 21. On each horizontal bar 20 or vertical bar 21, there are 1 or more tab stoppers 7′ to define the positions of each photograph of the photographs 3. These tab stoppers 7′ could be any geometrical shapes, and may be made with the same material as the bars 20 or 21. The clear panel or template 5′ is set in the main frame where the recess is. After having installed the clear panel or template 5′, the custom-cut photographs 3 will be placed accordingly. Finally the interior panel 4 is held in position by one or latches 6′, which are built-in on the main frame 11′.

Based on FIG. 12 and FIG. 13, an embodiment of the protective case for an electronic device, the complete assembly of a protective case of an electronic device can be formed with main frame 11″. The main frame 11″ has a built-in clear panel 5″, which is functioning as display windows. Along the edge of the main frame 11″ and the clear panel 5″, there is recess, which is able to accommodate the other components such as: horizontal bar dividers 22, vertical bar dividers 23, the photographs 3 and the interior panel 4. The horizontal bars 22 and the vertical bars 23 together are functioning as the template for user to be able to divide their displayed photographs 3 accordingly. There may be more than one horizontal bars 22, and each of which has openings 12 at both ends and where the openings 12 will serve as the connectors of the horizontal bars 22 to the series of studs 14 along the edge of the clear panel 5″ and the main frame 11″. As for the vertical bars 23, there may be more than one, and each of which has opening 13 at one end and chamfer at the other end to couple with the horizontal bar 22 where they are connected. And the openings 13 will serve as the connectors of the vertical bars 23 to the series of studs 14 along the edge of the clear panel 5″ and the main frame 11″. These horizontal bars 22 and vertical bars 23 are used as the template of the collage to determine to positions of each displayed photograph of the photographs 3. The series of studs 14 along the edge of the clear panel 5″ and the main frame 11″serve as the adjustable vertical positions of the horizontal bars 22 and the adjustable horizontal positions of the vertical bars 23. These adjustable positions of these bars give the user the flexibility of changing the template of their collage to display the photographs 3.

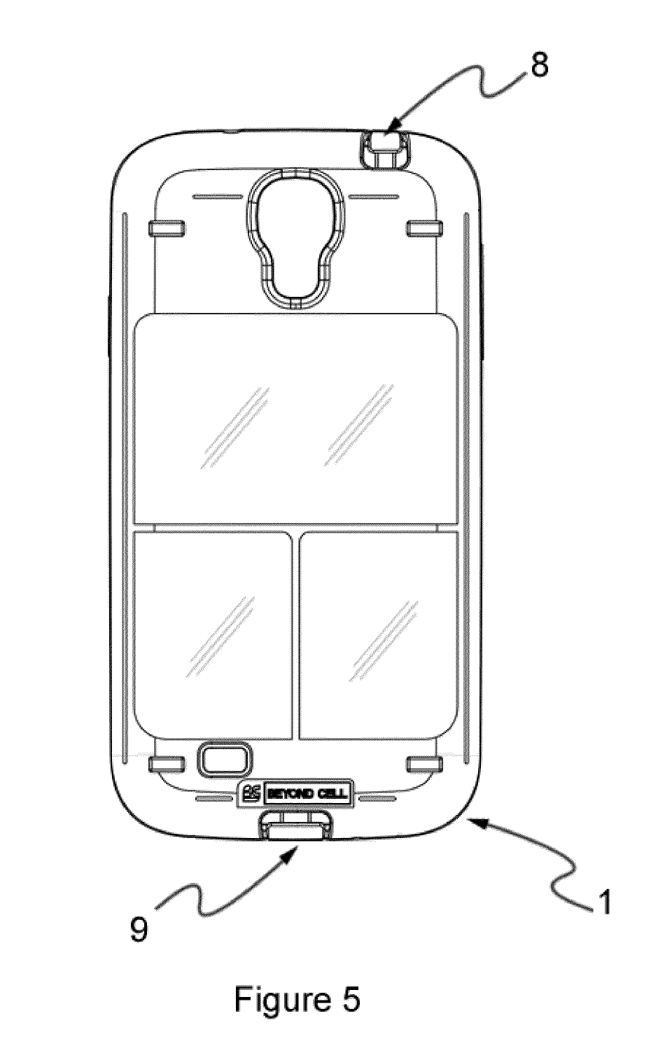

With reference to the FIGS. 5, 6, 7, 8, 9, 10 and 11, an embodiment of the present invention shows the protective case 1, where the protective case 1 has at least one dust cover to cover the audio port or a charging port. Where, on the top part of the protective case 1 comprises the dust cover 8, which covers the audio port. This dust cover 8 may be made with the same material as the main frame 11 and it is plugged directly onto the audio port of the electronic device. And where the dust cover 9 covers charger port and it may be made with the same material with the same material as the main frame 11 and it is plugged directly onto the charger port of the electronic device.

Although the foregoing description of the present invention has been described in considerable detail with reference to the preferred version thereof, it is not intended to be exhaustive or to limit the present invention to the precise form disclosed. Other versions are possible in light of the above detailed description of the present invention. For example, the display windows of the template may be in different shape(s) or geometrical form(s). Therefore, the spirit and the scope of the appended claims should not necessarily be limited to the description of the preferred version contained herein, and all changes that come within the meaning and range of equivalency of the claims are therefore intended to be embraced therein.

What is claimed is:

1. A protective case for an electronic device comprising a main frame with clear display panel as collage template to be able to display photographs and/or artworks.

2. A protective case for an electronic device of claim 1, wherein the said clear display panel is molded together with the main frame of the said protective case.

3. A protective case for an electronic device of claim 1, wherein the said clear display panel comprising a removable panel that is able to remove from the main frame of the said protective case of the said electronic device.

4. A protective case for an electronic device of claim 2, wherein the said clear display panel forms one complete panel transparent display window for the user to be able to display their favorite photographs or artworks.

5. A protective case for an electronic device of claim 4, wherein the said clear display panel is divided by one or more horizontal bars.

6. A protective case for an electronic device of claim 4, wherein the said clear display panel is divided by one or more vertical bars.

7. A protective case for an electronic device of claim 5, wherein the said horizontal bars are co-molded with the clear display panel.

8. A protective case for an electronic device of claim 6, wherein the said vertical bars are co-molded with the clear display panel.

9. A protective case for an electronic device of claim 5, wherein the said horizontal bars are built on different molding and are removable from the said clear display panel.

10. A protective case for an electronic device of claim 6, wherein the said vertical bars are built on different molding and are removable from the said clear display panel.

11. A protective case for an electronic device of claim 9, wherein the said horizontal bars are connected to the said main frame of the said protective case of the said electronic device with the stud/hole-male/female system.

12. A protective case for an electronic device of claim 10, wherein the said vertical bars are connected to the said main frame of the said protective case of the said electronic device with the stud/hole-male/female system.

13. A protective case for an electronic device of claim 5, wherein the said horizontal bars consists of at least one tab stopper to be able to define the position of the photographs or artworks.

14. A protective case for an electronic device of claim 6, wherein the said vertical bars consists of at least one tab stopper to be able to define the position of the photographs or artworks.

15. A protective case for an electronic device of claim 3, wherein the said main frame comprises an opening in the center portion to be able to accommodate the said clear display panel.

16. A protective case for an electronic device of claim 15, wherein the said main frame and the said clear display panel are connected with lap joint system.

17. A protective case for an electronic device of claim 1, wherein the said main frame comprises at least one dust cover to be able to protect the said electronic device from dust and other debris to get in the opening port of the said electronic device.

18. A protective case for an electronic device of claim 2, where the said main dust cover is molded with the said main frame of the said protective case.

19. A protective case for an electronic device of claim 2, where the said main dust cover is made with the same material as the said main frame of the said protective case.
